(19) United States
(12) Patent Application Publication
(10) Pub. No.: US 2025/0336159 A1
(43) Pub. Date: Oct. 30, 2025

(54) NESTED MIXED REALITY VOYAGES

(71) Applicant: Royal Caribbean Cruises, Ltd., Miami, FL (US)

(72) Inventors: Mary Reilly, Miami, FL (US); Joshua T Nakaya, Biscayne Park, FL (US); Jay Francis Schneider, Key Biscayne, FL (US)

(73) Assignee: Royal Caribbean Cruises, Ltd., Miami, FL (US)

(21) Appl. No.: 18/650,315

(22) Filed: Apr. 30, 2024

(51) Int. Cl. G06T 19/00; G06F 3/01; G06F 3/16

(52) U.S. Cl. CPC G06T 19/006; G06F 3/011; G06F 3/016; G06F 3/165

(57) ABSTRACT

A nested mixed reality vehicle includes a primary vehicle with an interior compartment adapted to propel onboard passengers from a geographic port of departure to a geographic port of destination, a secondary vehicle defining a cabin space and disposed within the interior compartment, a set of passenger seating fixtures disposed within the cabin space, a display panel fixed to an interior surface of the interior compartment adjacent to the set of passenger seating fixtures and framed at a perimeter of the display panel with a window frame so as to render an appearance of the display panel as a window and a host computing platform with at least one processor and memory and coupled to the display panel. The processor presents pre-produced video imagery in the display of an outdoor environment of an exterior of the secondary vehicle simulating a view from a third vehicle traversing the outdoor environment.

### BACKGROUND OF THE INVENTION

### Field of the Invention

The present invention relates to the technical field of leisure travel and more particular to the integration of mixed reality in a single voyage in order to produce a nested voyage.

### Description of the Related Art

Leisure travel often includes the movement of a passenger in a vehicle from one location to another, such as that of an aircraft, train or ship. Once the passenger has entered the vehicle, the ensuing voyage is of a singular dimension, directly tied to the manner in which the vehicle traverses a route. In some instances, though, in the course of a contemporaneous voyage of a particular vehicle, it can be desirable to experience a completely different voyage by a completely different vehicle at a completely different location. So much, however, becomes possible only once the contemporaneous voyage has completed and even then, the purchase of two separate voyage is required—an expense out of reach of most leisure travelers.

### BRIEF SUMMARY OF THE INVENTION

Embodiments of the present invention address technical deficiencies of the art in respect to mixed reality. To that end, embodiments of the present invention provide for a novel and non-obvious method for a nested mixed reality vehicle. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a nested mixed reality vehicle includes a primary vehicle with an interior compartment that has been adapted to propel a multiplicity of onboard passengers from a geographic port of departure to a geographic port of destination. The nested mixed reality vehicle further includes a secondary vehicle defining a cabin space and disposed within the interior compartment. Yet further, the nested mixed reality vehicle includes a set of passenger seating fixtures disposed within the cabin space of the secondary vehicle. The nested mixed reality vehicle even yet further includes at least one display panel fixed to an interior surface of the interior compartment adjacent to the set of passenger seating fixtures and framed at a perimeter of each display panel with a window frame so as to render a collective appearance of the display panels as a bank of windows.

Finally, the nested mixed reality vehicle includes a host computing platform with at least one processor and memory and coupled to the display panel. The processor executes computer program instructions in the memory which are configured during execution to present pre-produced video imagery in the display of an outdoor environment of an exterior of a third vehicle. In this way, passengers seated at the seating fixtures within the interior compartment of the secondary vehicle are visually led to believe that the secondary vehicle propels the passengers on a voyage which differs from the voyage of the primary vehicle propelling the passengers at the same moment in time.

In one aspect of the embodiment, the primary vehicle and the secondary vehicle are vehicles of different types, but the secondary vehicle and the third vehicle are vehicles of a same type. To that end, the primary vehicle can be a ship and the secondary vehicle can be a railcar. In another aspect of the embodiment, the seating fixtures include haptic feedback elements actuated in synchronization with specific frames of the pre-recorded video imagery. For instance, the specific frames can present imagery pre-recorded while the secondary vehicle traverses a railroad crossing while the haptic feedback elements provide the corresponding physical feedback of traversing the crossing.

In yet another aspect of the embodiment, the nested mixed reality vehicle additionally includes lighting in the interior compartment that has been configured to deactivate in synchronization with specific frames of the video imagery simulating the secondary vehicle traversing a tunnel. In even yet another aspect of the embodiment, the nested mixed reality vehicle has at least two audio output devices disposed at opposite portions of the cabin space so that audio playback is delayed at one of the audio output devices relative to another of the audio output devices. Finally, in even yet another aspect of the embodiment, the nested mixed reality vehicle has a motion sensor adapted to sense motion within the cabin space, such that the computer program instructions in the memory are further configured during execution to change the video imagery in the display.

In another embodiment of the invention, a nested mixed reality method is provided for use in a primary vehicle that has been adapted to propel a multiplicity of onboard passengers from a geographic port of departure to a geographic port of destination. The primary vehicle includes an interior compartment and a secondary vehicle disposed within the interior compartment. The secondary vehicle defines a cabin space, a set of passenger seating fixtures disposed within the cabin space of the secondary vehicle, and at least one display panel fixed to an interior surface of the interior compartment adjacent to the set of passenger seating fixtures. Each of the display panels are framed at a perimeter thereof with a window frame so as to render a collective appearance of the display panels as a bank of windows.

The method includes generating video imagery simulating a view from a third vehicle as the third vehicle traverses an outdoor environment and presenting the generated video imagery in the display of the secondary vehicle of the primary vehicle. In this way, the technical deficiencies of the simulation of heterogeneous travel in a secondary vehicle for passengers aboard a primary vehicle are overcome owing to the mixed reality display of the imagery in the display panel simulating movement of the secondary vehicle while the secondary vehicle remains stationary within the primary vehicle exhibiting, in reality, completely different movement.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a nested mixed reality vehicle;

FIG. 2 is a schematic diagram depicting a structural architecture of a nested mixed reality vehicle; and,

FIG. 3 is a flow chart illustrating a process for nested mixed reality for use in a nested mixed reality vehicle.

### DETAILED DESCRIPTION OF THE INVENTION

Embodiments of the invention provide for a nested mixed reality vehicle. In accordance with an embodiment of the invention, a secondary vehicle is formed within a primary vehicle, such as a train car within a cruise ship. Different digital display panels are fixed to the walls of the secondary vehicle in simulation of respectively different windows. Video imagery captured from yet a third vehicle is presented in the display panels in order to simulate movement of the secondary vehicle which is different than the movement of the primary vehicle. Optionally, haptic feedback is presented through interface elements of an interior portion of the secondary vehicle responsive to specific portions of the video imagery, such as the haptic shaking of a chair or the flickering of lighting. In this way a fictional voyage in the secondary vehicle is presented to a passenger within the interior portion of the secondary vehicle which differs from an actual voyage of the primary vehicle in which the secondary vehicle has been nested.

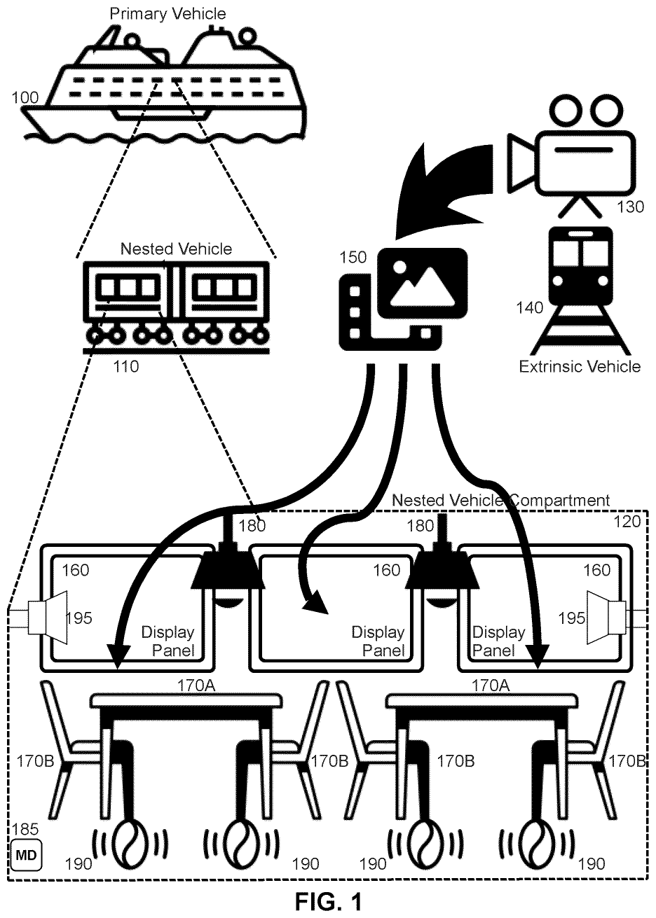

In illustration of one aspect of the embodiment, FIG. 1 pictorially shows a nested mixed reality vehicle. As shown in FIG. 1, a nested vehicle 110 is incorporated within a primary vehicle 100. Preferably, the nested vehicle 110 is of a different type from the primary vehicle 100. An interior cabin 120 of the nested vehicle 110 includes different seating fixtures 170B arranged about respectively different tables 170A and positioned adjacent to one or more computer display panels 160 framed to appear as windows of the nested vehicle 110.

Imagery 150 of a view outside of a window of a comparable vehicle to the nested vehicle 110 is presented within each of the display panels 160, but at offset timing in order to simulate movement of the nested vehicle 110 in a particular direction. The imagery 150 can be assembled from previously stored imagery, or generated from seed data such as through the use of a generative artificial intelligence engine, or a combination thereof. As another option, the imagery 150 can be captured from camera 130 fixed to extrinsic vehicle 140, optionally of the same type as the nested vehicle 110, and stored for subsequent playback as described hereinabove.

Notably, haptic feedback elements 190 are fixed to the seating fixtures 170B and are configured to activate in response to specific portions of the imagery 150. Consequently, vibration of the nested vehicle 110 can be simulated at different locations of a fictional journey represented by the imagery 150. Similarly, lighting elements 180 are configured to deactivate and re-activate in response to specific portions of the imagery 150 so as to simulate the passing of the nested vehicle 110 through different locations of the fictional journey represented by the imagery 150.

As another option, audio output devices 195 are positioned at opposite ends of the interior cabin 120 and activated to emit a common sound offset by a delay responsive to specific portions of the imagery 150 to audibly simulate the movement of the nested vehicle 110 through different locations of the fictional journey represented by the imagery 150. Finally, a motion detector 185 is positioned within the interior cabin 120 and is operable to trigger an activation of the lighting elements 180 in response to detecting movement of individuals within the interior cabin 120 of the nested vehicle 110.

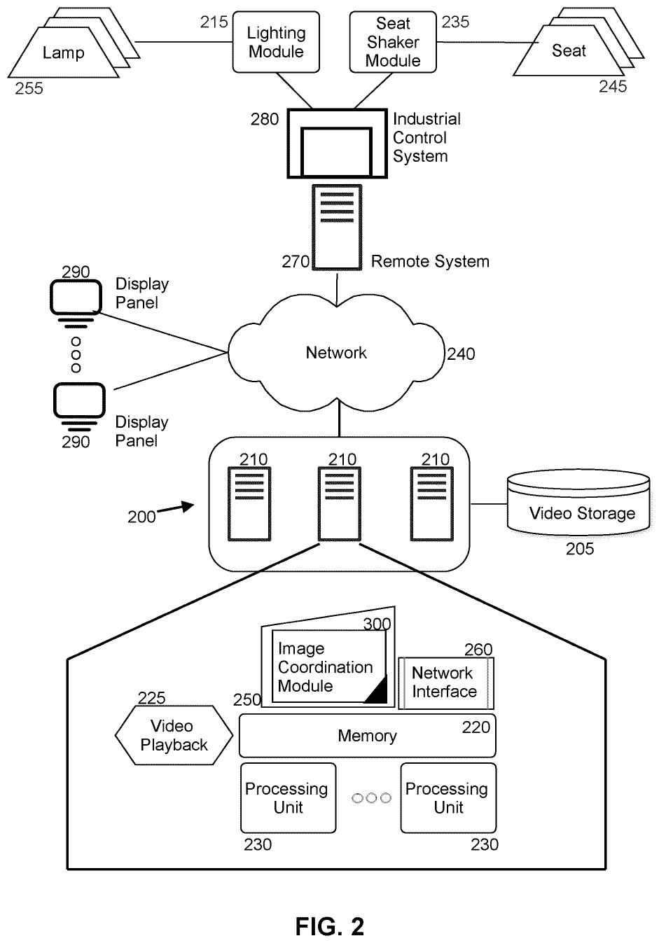

Aspects of the process described in connection with FIG. 1 can be implemented within a structural architecture including a data processing system. In further illustration, FIG. 2 depicts a structural architecture of a nested mixed reality vehicle. In the structural architecture illustrated in FIG. 2, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

The host computing platform 200 is communicatively coupled to different display panels 290 of the interior portion of the nested vehicle. The host computing platform 200 further is communicatively coupled to a remote computing device 270 hosting an industrial control system 280 adapted to signal each of a lighting module 215 and a seat shaker module 235. The lighting module 215 has circuitry sufficient to activate and deactivate different lamps 255 positioned within the interior cabin of the nested vehicle responsive to electrical prompts emitted by the industrial control system 280. Similarly, the seat shaker module 235 has circuitry sufficient to activate and deactivate different seat vibration servos positioned at each seat 245 within the interior cabin of the nested vehicle responsive to electrical prompts emitted by the industrial control system 280.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for managing nested mixed reality in the nested vehicle. Specifically, the program instructions during execution retrieve from video storage 205 a particular video recorded by an extrinsic vehicle at a window of the extrinsic vehicle as the extrinsic vehicle traverses terrain which differs from that of the primary vehicle encapsulating the nested vehicle.

The program instructions then direct playback of the retrieved video in each of the display panels 290, but at offset timing to simulate movement of the nested vehicle. The program instructions yet further monitor different portions of the retrieved video in order to detect feedback moments in response to which the program instructions direct the industrial control system 280 to initiate feedback through either the lighting module 215, or the seat shaker module 235. In this way, an individual sitting at one of the seats 245 within the interior cabin experiences a fictional journey reflective of the retrieved video which differs from the actual voyage experienced by the end user at the primary vehicle in which the secondary vehicle has been nested.

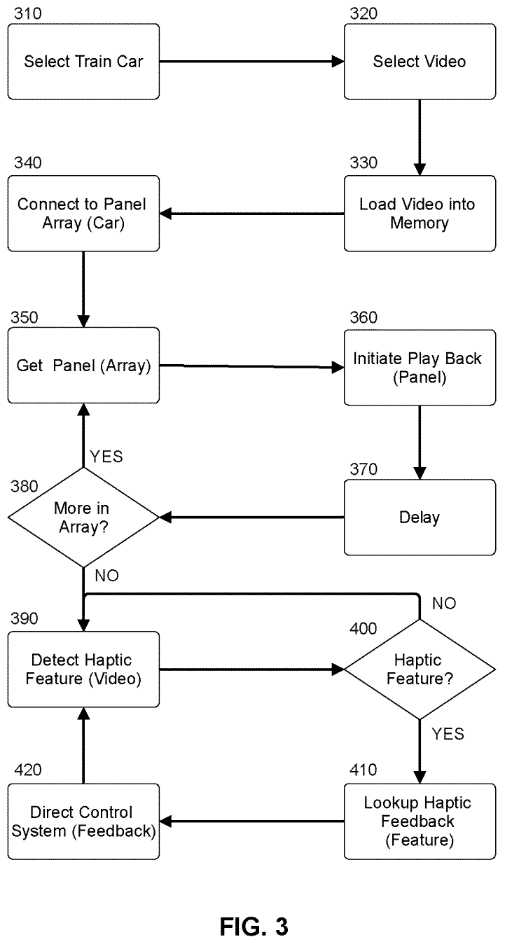

In further illustration of an exemplary operation of the module, FIG. 3 is a flow chart illustrating one of the aspects of the process of managing a nested mixed reality vehicle. Beginning in block 310, a train car mock up nested within a primary vehicle such as a cruise ship is selected for nested mixed reality and in block 320, a specific video of a particular voyage, previously filmed from an extrinsic vehicle, is selected for playback in the nested vehicle. Then, in block 330, the selected video is loaded into memory and in block 340, an array of panels is determined for the nested vehicle for the train car.

In block 350, a first panel in the array is selected and in block 360, playback of the specific video is initiated for the first panel. A delay is then incurred at block 370 and in decision block 380, if additional panels in the array remain, in block 350, the process repeats for a next panel in the array. When no further panels remain in the array, in block 390, the video during playback is monitored for specific haptic feedback moments such as imagery associated with the nested vehicle traversing a specific terrain feature or structure feature. In decision block 400, upon detecting a haptic feature, in block 410 a particular haptic feedback feature is mapped to the haptic feedback moment, such as a shaking of a seat, or the flickering of the lamps of the nested vehicle, or the playback of audio on delay from one speaker at one end of the interior cabin to the other end. Thereafter, in block 420, the industrial control system is directed to execute the haptic feedback feature. The process then repeats through block 390 for the remainder of the playback of the specific video.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A nested mixed reality vehicle comprising:
a primary vehicle adapted to propel a multiplicity of onboard passengers from a geographic port of departure to a geographic port of destination, the primary vehicle comprising an interior compartment;
a secondary vehicle disposed within the interior compartment and defining a cabin space;
a set of passenger seating fixtures disposed within the cabin space of the secondary vehicle;
a display panel fixed to an interior surface of the interior compartment adjacent to the set of passenger seating fixtures and framed at a perimeter of the display panel with a window frame so as to render an appearance of the display panel as a window; and,
a host computing platform comprising at least one processor and memory and coupled to the display panel, the processor executing computer program instructions in the memory configured during execution to present pre-produced video imagery in the display of an outdoor environment of an exterior of a third vehicle.

2. The nested mixed reality vehicle of claim 1, wherein the primary vehicle and the secondary vehicle are vehicles of different types, but the secondary vehicle and the third vehicle are vehicles of a same type.

3. The nested mixed reality vehicle of claim 2, wherein the primary vehicle is a ship and the secondary vehicle is a railcar.

4. The nested mixed reality vehicle of claim 1, wherein the seating fixtures comprise haptic feedback elements actuated in synchronization with specific frames of the pre-recorded video imagery.

5. The nested mixed reality vehicle of claim 4, wherein the specific frames present imagery pre-recorded while the secondary vehicle traverses a railroad crossing.

6. The nested mixed reality vehicle of claim 1, further comprising lighting in the interior compartment configured to deactivate in synchronization with specific frames of the pre-recorded video imagery pre-recorded while the secondary vehicle traverses a tunnel.

7. The nested mixed reality vehicle of claim 1, further comprising at least two audio output devices disposed at opposite portions of the cabin space and wherein an audio playback is delayed at one of the audio output devices relative to another of the audio output devices.

8. The nested mixed reality vehicle of claim 1, further comprising a motion sensor adapted to sense motion within the cabin space, wherein the computer program instructions in the memory are further configured during execution to change the pre-recorded video imagery in the display.

9. A nested mixed reality method for use in a primary vehicle adapted to propel a multiplicity of onboard passengers from a geographic port of departure to a geographic port of destination, the primary vehicle comprising an interior compartment and a secondary vehicle disposed within the interior compartment and defining a cabin space, a set of passenger seating fixtures disposed within the cabin space of the secondary vehicle, and at least one display panel fixed to an interior surface of the interior compartment adjacent to the set of passenger seating fixtures with each said display panel being framed at a perimeter thereof with a window frame so as to render an appearance of one or more display panels as a bank of windows, the method comprising:
generating video imagery simulating a view through a window of a third vehicle as the third vehicle traverses an outdoor environment;
presenting the generated video imagery in the display of the secondary vehicle of the primary vehicle.

10. The method of claim 9, wherein the primary vehicle and the secondary vehicle are vehicles of different types, but the secondary vehicle and the third vehicle are vehicles of a same type.

11. The method of claim 10, wherein the primary vehicle is a ship and the secondary vehicle is a railcar.

12. The method of claim 9, wherein the seating fixtures comprise haptic feedback elements actuated in synchronization with specific frames of the video imagery.

13. The method of claim 12, wherein the specific frames present imagery simulating the secondary vehicle traversing a railroad crossing.

14. The method of claim 9, further comprising lighting in the interior compartment configured to deactivate in synchronization with specific frames of the video imagery simulating the secondary vehicle traversing a tunnel.

15. The method of claim 9, further comprising delaying an audio playback at one of at least two audio output devices disposed at opposite portions of the cabin space, relative to another of the audio output devices.

16. The method of claim 9, further comprising changing the generated video imagery in the display responsive to a motion sensor adapted to sense motion within the cabin space.
